(19) United States
(12) Patent Application Publication
(10) Pub. No.: US 2025/0075049 A1
(43) Pub. Date: Mar. 6, 2025

(54) BLOW FILM FEEDSTOCK AND METHOD OF MAKING

(71) Applicant: Viaflex, Inc., Sioux Falls, SD (US)

(72) Inventor: Chris Tuschen, Sioux Falls, SD (US)

(21) Appl. No.: 18/818,427

(22) Filed: Aug. 28, 2024

Related U.S. Application Data
(60) Provisional application No. 63/579,648, filed on Aug. 30, 2023.

(51) Int. Cl. C08J 11/06; C08J 5/18

(52) U.S. Cl. CPC C08J 11/06; C08J 5/18; C08J 2323/06; C08J 2323/12; C08J 2479/08

(57) ABSTRACT

A device may include a film conventionally considered recyclable material in a range of about 2 wt % to about 100 wt % of the feedstock; and a multi-layer film conventionally considered to be non-recyclable, wherein the recyclable film and the non-recyclable films contain polymers that are immiscible.

### CROSS-REFERENCE TO RELATED APPLICATION

This application claims the benefit of priority to U.S. Provisional Patent Application Ser. No. 63/579,648 entitled “BLOW FILM FEEDSTOCK AND METHOD OF MAKING,” filed Aug. 30, 2023, the disclosure of which is incorporated herein in its entirety by reference.

### BACKGROUND

As substantial amount of post-consumer and post-industrial plastic waste is not recycled. Impediments to the recycling of commodity polymers include separation, impurities and degradation of the macromolecular structures, all of which can negatively affect the properties of recycled materials. It is desirable to find ways to increase the ability to recycle post-consumer and post-industrial plastic waste especially with plastic waste that is not conventionally considered to be recyclable.

### SUMMARY OF THE DISCLOSURE

In some aspects, the techniques described herein relate to a feedstock including: a film conventionally considered recyclable material in a range of about 2 wt % to about 100 wt % of the feedstock; and a multi-layer film conventionally considered to be non-recyclable, wherein the recyclable film and the non-recyclable films contain polymers that are immiscible.

In some aspects, the techniques described herein relate to a blown or cast film formed from a feedstock including: a conventionally considered recyclable film material in a range of about 2 wt % to about 35 wt % of the feedstock; and a multi-layer film considered to be non-recyclable, wherein the recyclable film material and portions of the non-recyclable film are immiscible.

In some aspects, the techniques described herein relate to a method of making a feedstock, the method including: feeding a film including a recyclable polymer material and multilayer film including a non-recyclable polymer material into a twin screw extruder; extruding the feedstock, wherein the feedstock includes: a recyclable polymer material in a range of about 2 wt % to about 35 wt % of the feedstock; and a non-recyclable polymer, wherein the recyclable polymer material and portions of the non-recyclable polymer are immiscible.

### DETAILED DESCRIPTION OF THE DISCLOSURE

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.”

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “polyamide” as used herein refers to polymer having repeating units linked by amide bonds. Polyamides may arise from monomers comprising aliphatic, semi-aromatic or aromatic groups. Polyamide includes nylons, e.g., nylon-6,6 or nylon-6, and may refer to polyamides arising from a single monomer, two different monomers, or three or more different monomers. The term polyamide thus includes dimonomeric polyamides. The polyamide may be a nylon having as monomer units a dicarboxylic acid monomer unit and a diamine monomer unit. For example, if the dicarboxylic acid monomer unit is adipic acid and the diamine is hexamethylene diamine, the resulting polyamide can be nylon-6,6. Nylon-6 is a polyamide having a caprolactam monomer. The polyamide may be copolymers which may be prepared from aqueous solutions or blends of aqueous solutions that contain more than two monomers. In various aspects, polyamides can be manufactured by polymerization of dicarboxylic acid monomers and diamine monomers. In some cases, polyamides can be produced via polymerization of aminocarboxylic acids, aminonitriles, or lactams. Suitable polyamides include, but are not limited, to those polymerized from the monomer units described herein. The term “polyamide” includes polyamides such as PA6, PA66, PA11, PA12, PA612, Nylon-66/6T. However, this term can be modified, when done so expressly, to exclude particular polyamides. For example, in some aspects, the polyamide can be a polyamide other than PA11, PA12, and PA612; or the polyamide can be a polyamide other than Nylon-66/6T.

The term “N6,” “nylon-6,” or “PA6” as used herein, refers to a polymer synthesized by polycondensation of caprolactam. The polymer is also known as polyamide 6, nylon-6, and poly(caprolactam).

The term “N66,” “nylon-6,6,” or “PA66” as used herein, refers to a polymer synthesized by polycondensation of hexamethylenediamine (HMD) and adipic acid. The polymer is also known as Polyamide 66, nylon-66, nylon-6-6, and nylon-6/6.

The polymers described herein can terminate in any suitable way. In some aspects, the polymers can terminate with an end group that is independently chosen from a suitable polymerization initiator, —H, —OH, a substituted or unsubstituted (C₁-C₂₀) hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

The production and use of plastic films have become ubiquitous in society, offering numerous benefits in packaging, insulation, and construction applications. However, the pervasive presence of unrecyclable films containing immiscible polymers poses a significant challenge to sustainable waste management. Films composed of polymers such as polyethylene (PE), ethylene vinyl alcohol (EVOH), nylon, polyethylene terephthalate (PET), and polyurethane (PU) are commonly used due to their unique properties but are often difficult to recycle due to their incompatible nature, especially when coextrude in multilayer film structures. This incompatible nature, when used in the production of blown or cast films, results in an unacceptable level of defects (otherwise known as gels) and holes in the films produced.

Miscibility is a thermodynamic term that describes a number of phases within the polymer blends. Polymers are based on miscibility, which are again subgrouped into: (1) completely miscible polymers; (2) partially miscible polymers; and (3) completely immiscible polymers. The glass transition temperature (T_{g}) and morphology are used to determine the miscibility of polymer blends. For miscible polymers, the T_{g} value will be a single entity, whereas for heterogeneous partially immiscible polymer blends, the T_{g} value will be shifted toward one of the polymers and, for completely immiscible polymer blends, there will be two values of T_{g} for each material. Also, the morphology of the polymer blends turns from coarse morphology to fine morphology which improves the adhesion and surface tension by allowing stress transfer between the phases that improves the performance of the polymer blends.

Traditional recycling processes struggle to separate and recycle these immiscible polymer films effectively, resulting in their accumulation in landfills and contributing to environmental pollution. Current approaches for handling these films involve incineration, downcycling, chemical recycling, or the use of chemical compatibilizers. All of these have significant drawbacks, including excessive costs, or the materials not being used back into a productions process.

A polymer can be recycled by taking an existing waste feedstock and repurposing it for another use. As an example, a waste feedstock can be shredded into flakes or chips or fibers. The feedstock can be obtained from a municipal residential, commercial or industrial waste stream. In some examples the waste stream preferably has been sorted to remove metals, organics, or the like. Alternatively, a waste can be melt processed to form polymer pellets that are formed into new products.

According to the disclosure, features and benefits will relate to a method of recycling coextruded and reinforced films. Benefits associated with the instant disclosure can relate to significantly reduce waste, promote circular economy principles, and contribute to a more sustainable future by enabling the recycling of previously unrecyclable films with immiscible polymers.

The feedstock produced generally includes material of a film conventionally considered recyclable material as well as a multi-layer film, string, fiber, or reinforced film that are considered to be non-recyclable. A recyclable material refers to the ability of a material to be reused, reconditioned for use, or recycled through existing recycling collection programs. Conversely, a non-recyclable material refers to the material's properties that prevent it from being reused, reconditioned for use, or recycled through existing recycling collection programs. The feedstock can be in the form of a pellet or flake.

The recyclable material can be present in a range of about 2 wt % to about 100 wt % of the feedstock, about 5 wt % to about 40 wt %, about 10 wt % to about 35 wt %, less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100 wt %. The recyclable material can include a polymer material such as a polyolefin, a polyamide, a polyester, a polyether, a polycarbonate, a polyolefin, a polystyrene, a polyacrylate, a polyvinyl chloride, a polyvinyl ether, a fluoropolymer, a copolymer thereof, or a mixture thereof. In some aspects, the recyclable polymer is already recycled before being incorporated into the film. For example, the recyclable polymer can be mechanically recycled before being incorporated into the feedstock.

In some aspects, particularly well suited recyclable polymers include polyolefins such as polyethylene or polypropylene. The polyethylene can be a low-density polyethylene, a high-density polyethylene, an ultra high-density polyethylene, or a mixture thereof.

The non-recyclable material can generally be sourced from a multi-layer film that has been used, but not recycled. The non-recyclable material in in a range of about 2 wt % to about 50 wt % of the feedstock, about 5 wt % to about 40 wt %, about 10 wt % to about 30 wt %, less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 wt %. Examples of materials that are in the non-recyclable material include polyethylene terephthalate, a polyamide, a polyurethane, ethylene vinyl alcohol, or a mixture thereof. Examples of polyamides include: nylon-6; nylon-6,6; nylon-4,6; nylon-5,6; nylon-5,10; nylon-4,10; nylon-6,10; nylon-7; nylon-11; nylon-12; a copolymer of nylon-6, a copolymer of nylon-6 or nylon-6,6 having at least one repeating unit that is poly(hexamethylene terephtalamide), poly(hexamethylene isophthalamide), or a copolymer of poly(hexamethylene terephtalamide) and poly(hexamethylene isophthalamide); a mixture thereof; or a copolymer thereof.

In general, the recyclable film and the non-recyclable films contain polymers that are immiscible. The feedstock created can be used to make a blown film. The blown film is made using blown film extrusion. Blown film extrusion is a process that involves melting plastic pellets and extruding them through a circular die. As the plastic is extruded, the air is blown into the center of the die, causing the molten plastic to expand into a bubble or tube.

The tube is then cooled and collapsed, creating a thin film that can be wound onto rolls for further processing or use. The thickness of the film can be controlled by adjusting the speed of the extruder, the airflow, and the size of the die.

The blown film machines are a machine that melts plastic particles through a screw and then blows the melted flowing plastic into a film through a specific mold.

Blown film extrusion requires several pieces of equipment, including an extruder, a circular die, an air ring, and a collapsing frame.

The extruder is used to melt and pump the plastic material to the die, while the air ring supplies the air to inflate the bubble.

The collapsing frame is used to cool and collapse the tube into a flat film, which is then wound onto rolls for further processing or use.

The process of blown film extrusion can be broken down into several stages, including:
1. Preparing the Material: The plastic pellets are fed into the extruder and melted, creating a homogeneous mass of molten plastic.
2. Extrusion: The molten plastic is pumped through the circular die, and the air is blown into the center of the die to create a bubble or tube.
3. Cooling: The tube is cooled by passing it through a series of cooling rollers or by blowing air onto it.
4. Collapsing: The tube is collapsed by passing it through a pair of collapsing rollers, which flatten it into a thin film.
5. Winding: The film is wound onto rolls for further processing or use.

The feedstock is made using a twin screw extruder. To ultimately form a smooth and substantially defect free blown or cast film when processing films with immiscible polymers, screw design and process conditions are carefully controlled. Overall, the process of forming the feedstock acts like using a mortar and pestle. That is the screws of the extruder function in breaking the immiscible non-recyclable polymers down into a filler in the matrix of the recyclable polymer. In this manner the immiscible polymers are incorporated into a common structure that can be formed into a blown film. Some of the polymers within the scope of this disclosure, especially EVOH, can decompose, producing a foaming effect on the resultant strands or pellets. However, as explained further herein, there are processes available to mitigate this effect, where present.

A twin screw extruder is a machine including two intermeshing, co-rotating screws mounted on splined shafts in a closed barrel. The screws are tight and self-wiping, which eliminates stagnant zones over the entire length of the process section. This results in high efficiency and perfect self-cleaning. In the extruder, the screw design is such that an aggressive amount of dispersive mixing elements and sections are used. These elements produce high levels of shear, and do not allow the polymers to traverse the barrel without passing through a low clearance gap. The low clearance gap is either between the element and the barrel, or the lobes of the two elements themselves.

The screw design of the twin screw extruder can be important for effectively processing immiscible polymers. The design should incorporate an aggressive amount of dispersive mixing elements, such as kneaders of varying pitch and length. Elements like blisters, reverse conveying sections, or similar should be used to create pressure zones that increase polymer residence time in high shear/dispersive mixing areas. This configuration helps break down the immiscible contaminant polymers into a filler within the matrix of the primary resin.

In some aspects, the feedstock can be processed from 100% post-industrial recycle (PIR) inputs. Initial trials with PIR inputs, controlled to represent the highest level of non-PE contaminants available from in-plant produced PIR, have shown consistent defect levels and physical test results comparable to trials using virgin resin as inputs.

The method can incorporate various immiscible resins into the feedstock. For example, ethylene vinyl alcohol (EVOH), nylon, and polyurethane can be incorporated at levels of about 3.5 wt %, in combination with PET at about 30 wt %, about 6 wt % to about 20 wt %, less than, equal to, or greater than about 3.5 wt %, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or about 30 wt %. Films produced with these compositions have been successfully manufactured without defects or holes and exhibit a smooth finish similar to films made from virgin resin.

The most common type of element used for this is referred to as a kneader. Kneaders of varying pitch and length can be used, but the specific design directly impacts the specific mechanical energy (SME). In order to further maximize the effect of these sections, screw elements such as blisters, reverse conveying sections, or other elements that have a similar effect, can be included to create a pressure zone that increases the residence time of the polymers in that high shear/dispersive mixing area of the screw.

There is a range of SME that will produce a quality, substantially defect free film. For example, SME values ranging from about 0.32 kWhr/kg to about 0.39 kWhr/kg, about 0.33 kWhr/kg to about 0.38 kWhr/kg, less than, equal to, or greater than about 0.32 kWhr/kg, 0.33, 0.34, 0.35, 0.36, 0.37, 0.38, or about 0.39 kWhr/kg produce film comparable in defect levels to that of prime resin. It has been found that the levels dropping below 0.32 kWhr/kg result in materials where defects begin to appear more frequently. As SME levels increase, greater levels of volatiles are produced, resulting in the foaming action previously mentioned. At too high of a level, the process becomes self-limiting due to shear thinning of the material resulting in an inability to pelletize. For example, an upper boundary of the SME may be at about 0.39 kWhr/kg.

In addition to utilizing enough energy to reduce the defects to a small enough size to act as a filler, vacuum devolatilization is used to mitigate the foaming action. The pressure conditions used in vacuum devolatilization range from about 80 bar to about 110 bar, about 95 bar to about 104 bar, less than, equal to, or greater than about 80 bar, 81, 82, 83, 84, 85, 86, 87, 88, 89, 90, 91, 92, 93, 94, 95, 96, 97, 98, 99, 100, 101, 102, 103, 104, 105, 106, 107, 108, 109, or about 110 bar. When using an underwater pelletizer, this foaming appears on the pellets first as a fuzz, and looks more like short hair on the pellets. For a strand pelletizer, the strand swelling as it exits the die increases and eventually begins to lose enough integrity that the strands continually break. Introducing a vacuum devolatilization section to the screw design allows for elimination of this phenomenon, it has been shown pellet density increased by as much as 22%, relative to a corresponding feedstock that did not undergo devolatilization.

### Examples

Various aspects of the present disclosure can be better understood by reference to the following Examples which are offered by way of illustration. The present disclosure is not limited to the Examples given herein.

Initial experiments focused on incorporating PET, sourced from fiber reinforced films, into recycled pellets that were subsequently used into both blown and cast films. The material was first processed on a plastic recycling line by shredding the films, which were then passed serially through two single screw extruders and pelletized on an underwater pelletizer. The PET content of the resultant pellets was estimated to be in a range of 23-24 weight percent, with the balance of the polymer weight consisting of PE, and standard UV and anti-oxidant additives.

The PET containing pellets were then introduced to a co-rotating twin screw extruder allowing the final weight percentage of PET to range from 5.0-20.0%. The PET containing recycle material was blended with different PE polymers, such as standard metallocene and octenes. In order for the material to be successfully processed, a combination of distributive and dispersive mixing sections need to be incorporated into the screw design. In addition, creating zones of back pressure, causing increased residence time in each of the mixing zones, was found to be useful for full incorporation of the immiscible polymers into the PE matrix.

Table 1 below represents ASTM standard physical test values from the varying blends. All of these values were normalized to the film thickness for more appropriate comparison. As can be seen, certain physical properties suffer more from an increased level of PET.

TABLE 1

| | | | | 20% | 17.5% | 15.0% | 12.5% | 10% | 7.5% | 5.0% |
|---|---|---|---|---|---|---|---|---|---|---|
| Property | Method | UNITS | | PET | PET | PET | PET | PET | PET | PET |
| Tensile | D882 | Ibf/in | MD | 38.42 | 34.92 | 49.69 | 53.96 | 60.64 | 65.68 | 65.35 |
| Load | | | TD | 34.01 | 21.57 | 34.76 | 41.69 | 49.97 | 56.78 | 52.43 |
| Graves | D1004 | Ibf | MD | 8.63 | 7.85 | 8.54 | 9.98 | 9.56 | 10.86 | 9.85 |
| Tear | | | TD | 10.76 | 10.07 | 10.55 | 10.29 | 9.71 | 10.27 | 9.60 |
| Puncture | D4833 | Ibf | | 27.05 | 22.41 | 29.76 | 35.20 | 35.99 | 42.37 | 36.86 |
| Impact | D1709 | g | | 481 | 481 | 702 | 1040 | 1374 | 1767 | 1900 |
| Resistance | | | | | | | | | | |

Further attempts to incorporate PET contamination into recycle resin were conducted using edge trim from the same product, but this material contained approximately 38 weight percent PET. Films with overlapping PET content as the previous efforts were successfully created with comparable results. A film containing 38 weight percent PET was attempted without success as the back pressure in the extruders were too high with the elevated level of contamination.

All films up to 20 weight percent PET were successfully produced without holes or significant defects present. Films produced with comparable loadings of PET had noticeable texture and defects abundantly present, although they too were produced without holes present in the films.

### Incorporation of EVOH/Nylon/TPU:

In addition to PET, other immiscible resins are capable of being successfully recycled through this process. Trials were completed incorporating EVOH, Nylon, and polyurethane at a 3.5 weight percent loading, in combination with PET at a 10 weight percent loading. The EVOH, Nylon, and polyurethane was introduced in the form of prime resin pellets at this point in testing.

Similar to the blends produced with just PET as a contaminant, the data shown in the Table 2 shows the drop off in physical values seen when compared to the control blend highlighted in gray for each thickness. These films were also successfully produced without defects or holes in them, and had a smooth finish as a new resin would.

TABLE 2

| | | | | | | | Tens | | Tens | | Darts % |
|---|---|---|---|---|---|---|---|---|---|---|---|
| | | | | | | Tens | MD % from | Tens | TD % from | | from |
| PE | % | Nylon | TPU | PET | Thickness | MD | Control | TD | Control | Darts | Control |
| 86.5% | 3.5% | 0.0% | 0.0% | 10.0% | 14.02 | 2.8 | −22% | 2.6 | −27% | 35.7 | −71% |
| 86.5% | 0.0% | 3.5% | 0.0% | 10.0% | 14.37 | 2.6 | −25% | 2.5 | −30% | 34.8 | −71% |
| 86.5% | 0.0% | 0.0% | 3.5% | 10.0% | 14.31 | 3.2 | −9% | 3.1 | −13% | 46.9 | −62% |
| 90% | 0.0% | 0.0% | 0.0% | 10.0% | 14.5 | 3.5 | | 3.5 | | 122.′ | |
| 86.5% | 3.5% | 0.0% | 0.0% | 10.0% | 1.81 | 2.0 | −37% | 1.0 | −45% | 41.4 | −58% |
| 86.5% | 0.0% | 3.5% | 0.0% | 10.0% | 1.87 | 1.8 | −44% | 1.0 | −47% | 54.8 | −44% |
| 86.5% | 0.0% | 0.0% | 3.5% | 10.0% | 1.96 | 1.9 | −40% | 1.1 | 40% | 52.9 | −46% |
| 90.0% | 0.0% | 0.0% | 0.0% | 10.0% | 1.63 | 3.1 | | 1.9 | | 98.7 | |

### 100% Scrap Processing:

After evaluating EVOH, nylon, and TPU introduced in prime resin form, and being blended with recycled PET containing resins and prime PE resin, the next step was to evaluate material produced from 100% post-industrial recycle (PIR). For initial trials, the PIR inputs were controlled to represent the highest level of non-PE contaminants available from in plant produced PIR. Only EVOH containing barrier films have been tested to date, with defect levels and physical test results remaining consistent with the trials produced using EVOH resin as inputs. It is assumed that comparable results will be seen when coextruded films containing nylon and TPU are tested, which will happen at a future date as materials become available.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present disclosure. Thus, it should be understood that although the present disclosure has been specifically disclosed by specific aspects and optional features, modification and variation of the concepts herein disclosed may be resorted to by those of ordinary skill in the art, and that such modifications and variations are considered to be within the scope of aspects of the present disclosure.

### Exemplary Aspects.

The following exemplary aspects are provided, the numbering of which is not to be construed as designating levels of importance:

Aspect 1 provides a feedstock comprising:
a film conventionally considered recyclable material in a range of about 2 wt % to about 100 wt % of the feedstock; and
a multi-layer film conventionally considered to be non-recyclable,
wherein the recyclable film and the non-recyclable films contain polymers that are immiscible.

Aspect 2 provides the feedstock of Aspect 1, wherein the feedstock is a pellet or a flake.

Aspect 3 provides the feedstock of any of Aspects 1 or 2, wherein the non-recyclable films contain polymer material comprised of polyethylene terephthalate, a polyamide, a polyurethane, ethylene vinyl alcohol, or a mixture thereof.

Aspect 4 provides the feedstock of Aspect 3, wherein the polyamide comprises:
nylon-6;
nylon-6,6;
nylon-4,6;
nylon-5,6;
nylon-5,10;
nylon-4,10;
nylon-6,10;
nylon-7;
nylon-11;
nylon-12;
a copolymer of nylon-6, a copolymer of nylon-6 or nylon-6,6 having at least one repeating unit that is:
   poly(hexamethylene terephtalamide),
   poly(hexamethylene isophthalamide), or
   a copolymer of poly(hexamethylene terephtalamide) and poly(hexamethylene isophthalamide);
a mixture thereof; or
a copolymer thereof.

Aspect 5 provides the feedstock of any of Aspects 1-4, wherein the recyclable film comprises polyethylene or polypropylene.

Aspect 6 provides the feedstock of any of Aspects 1-5, wherein the recyclable film comprises a mechanically recycled polymer.

Aspect 7 provides the feedstock of any of Aspects 1-6, wherein the recyclable film comprises polyamide, a polyester, a polyether, a polycarbonate, a polyolefin, a polystyrene, a polyacrylate, a polyvinyl chloride, a polyvinyl ether, a fluoropolymer, a copolymer thereof, or a mixture thereof.

Aspect 8 provides the feedstock of any of Aspects 1-7, wherein the recyclable film comprises a polyolefin.

Aspect 9 provides the feedstock of Aspect 8, wherein the polyolefin comprises a polyethylene or a polypropylene.

Aspect 10 provides the feedstock of Aspect 9, wherein the polyethylene comprises a low-density polyethylene, a high-density polyethylene, an ultra high-density polyethylene, or a mixture thereof.

Aspect 11 provides a blown film formed from a feedstock comprising:
a conventionally considered recyclable film material in a range of about 2 wt % to about 35 wt % of the feedstock; and
a multi-layer film considered to be non-recyclable,
wherein the recyclable film material and portions of the non-recyclable film are immiscible.

Aspect 12 provides the blown film of Aspect 11, wherein the non-recyclable film material comprises polyethylene terephthalate, a polyamide, a polyurethane, ethylene vinyl alcohol, or a mixture thereof combined with polyethylene or polypropylene.

Aspect 13 provides the blown film of Aspect 12, wherein the polyamide comprises:
nylon-6;
nylon-6,6;
nylon-4,6;
nylon-5,6;
nylon-5,10;
nylon-4,10;
nylon-6,10;
nylon-7;
nylon-11;
nylon-12;
a copolymer of nylon-6, a copolymer of nylon-6 or nylon-6,6 having at least one repeating unit that is
   poly(hexamethylene terephtalamide),
   poly(hexamethylene isophthalamide), or
   a copolymer of poly(hexamethylene terephtalamide) and poly(hexamethylene isophthalamide);
a mixture thereof; or
a copolymer thereof.

Aspect 14 provides the blown film of any of Aspects 12 or 13, wherein recyclable film comprises polyethylene terephthalate.

Aspect 15 provides the blown film of any of Aspects 11-14, wherein the recyclable film comprises a mechanically recycled polymer.

Aspect 16 provides the blown film of any of Aspects 11-15, wherein the non-recyclable film comprises a polyamide, a polyester, a polyether, a polycarbonate, a polyolefin, a polystyrene, a polyacrylate, a polyvinyl chloride, a polyvinyl ether, a fluoropolymer, a copolymer thereof, or a mixture thereof combined with polyethylene.

Aspect 17 provides the blown film of Aspect 16, wherein the polyolefin comprises a polyethylene or a polypropylene.

Aspect 18 provides the blown film of Aspect 17, wherein the polyethylene comprises a low-density polyethylene, a high-density polyethylene, an ultra high-density polyethylene, or a mixture thereof.

Aspect 19 provides a method of making a feedstock, the method comprising:
feeding a film comprising a recyclable polymer material and multilayer film comprising a non-recyclable polymer material into a twin screw extruder;
extruding the feedstock, wherein the feedstock comprises:
   a recyclable polymer material in a range of about 2 wt % to about 35 wt % of the feedstock; and
   a non-recyclable polymer,
   wherein the recyclable polymer material and portions of the non-recyclable polymer are immiscible.

Aspect 20 provides the method of Aspect 19, wherein the non-recyclable polymer material comprises polyethylene terephthalate, a polyamide, a polyurethane, ethylene vinyl alcohol, or a mixture thereof combined with polyethylene or polypropylene.

Aspect 21 provides the method of Aspect 20, wherein the polyamide comprises:
nylon-6;
nylon-6,6;
nylon-4,6;
nylon-5,6;
nylon-5,10;
nylon-4,10;
nylon-6,10;
nylon-7;
nylon-11;
nylon-12;
a copolymer of nylon-6, a copolymer of nylon-6 or nylon-6,6 having at least one repeating unit that is
   poly(hexamethylene terephtalamide),
   poly(hexamethylene isophthalamide), or
   a copolymer of poly(hexamethylene terephtalamide) and poly(hexamethylene isophthalamide);
a mixture thereof; or
a copolymer thereof.

Aspect 22 provides the method of any of Aspects 20 or 21, wherein the non-recyclable film contains polyethylene terephthalate.

Aspect 23 provides the method of any of Aspects 19-22, wherein the recyclable polymer comprises a mechanically recycled polymer.

Aspect 24 provides the method of any of Aspects 19-23, wherein the non-recyclable film is comprised of polymers such a polyamide, a polyester, a polyether, a polycarbonate, a polyolefin, a polystyrene, a polyacrylate, a polyvinyl chloride, a polyvinyl ether, a fluoropolymer, a copolymer thereof, or a mixture thereof, combined with polyethylene or polypropylene.

Aspect 25 provides the method of Aspect 24, wherein the polyolefin comprises a polyethylene or polypropylene.

Aspect 26 provides the method of Aspect 25, wherein the polyethylene comprises a low-density polyethylene, a high-density polyethylene, an ultra high-density polyethylene, or a mixture thereof.

What is claimed is:

1. A feedstock comprising:
a film conventionally considered recyclable material in a range of about 2 wt % to about 100 wt % of the feedstock; and
a multi-layer film conventionally considered to be non-recyclable,
wherein the recyclable film and the non-recyclable films contain polymers that are immiscible.

2. The feedstock of claim 1, wherein the feedstock is a pellet or a flake.

3. The feedstock of claim 1, wherein the non-recyclable films contain polymer material comprised of polyethylene terephthalate, a polyamide, a polyurethane, ethylene vinyl alcohol, or a mixture thereof.

4. The feedstock of claim 3, wherein the polyamide comprises:
nylon-6;
nylon-6,6;
nylon-4,6;
nylon-5,6;
nylon-5,10;
nylon-4,10;
nylon-6,10;
nylon-7;
nylon-11;
nylon-12;
a copolymer of nylon-6, a copolymer of nylon-6 or nylon-6,6 having at least one repeating unit that is:
poly(hexamethylene terephtalamide),
poly(hexamethylene isophthalamide), or
a copolymer of poly(hexamethylene terephtalamide) and poly(hexamethylene isophthalamide);
a mixture thereof; or
a copolymer thereof.

5. The feedstock of claim 1, wherein the recyclable film comprises polyethylene or polypropylene.

6. The feedstock of claim 1, wherein the recyclable film comprises a mechanically recycled polymer.

7. The feedstock of claim 1, wherein the recyclable film comprises polyamide, a polyester, a polyether, a polycarbonate, a polyolefin, a polystyrene, a polyacrylate, a polyvinyl chloride, a polyvinyl ether, a fluoropolymer, a copolymer thereof, or a mixture thereof.

8. The feedstock of claim 1, wherein the recyclable film comprises a polyolefin.

9. The feedstock of claim 8, wherein the polyolefin comprises a polyethylene or a polypropylene.

10. The feedstock of claim 9, wherein the polyethylene comprises a low-density polyethylene, a high-density polyethylene, an ultra high-density polyethylene, or a mixture thereof.

11. A blown film formed from a feedstock comprising:
a conventionally considered recyclable film material in a range of about 2 wt % to about 100 wt % of the feedstock; and
a multi-layer film considered to be non-recyclable,
wherein the recyclable film material and portions of the non-recyclable film are immiscible.

12. The blown film of claim 11, wherein the non-recyclable film material comprises polyethylene terephthalate, a polyamide, a polyurethane, ethylene vinyl alcohol, or a mixture thereof combined with polyethylene or polypropylene.

13. The blown film of claim 12, wherein the polyamide comprises:
nylon-6;
nylon-6,6;
nylon-4,6;
nylon-5,6;
nylon-5,10;
nylon-4,10;
nylon-6,10;
nylon-7;
nylon-11;
nylon-12;
a copolymer of nylon-6, a copolymer of nylon-6 or nylon-6,6 having at least one repeating unit that is
poly(hexamethylene terephtalamide),
poly(hexamethylene isophthalamide), or
a copolymer of poly(hexamethylene terephtalamide) and poly(hexamethylene isophthalamide);
a mixture thereof; or
a copolymer thereof.

14. The blown film of claim 12, wherein non-recyclable film comprises polyethylene terephthalate.

15. The blown film of claim 11, wherein the recyclable film comprises a mechanically recycled polymer.

16. The blown film of claim 11, wherein the non-recyclable film comprises a polyamide, a polyester, a polyether, a polycarbonate, a polyolefin, a polystyrene, a polyacrylate, a polyvinyl chloride, a polyvinyl ether, a fluoropolymer, a copolymer thereof, or a mixture thereof combined with polyethylene.

17. The blown film of claim 16, wherein the polyolefin comprises a polyethylene or a polypropylene.

18. The blown film of claim 17, wherein the polyethylene comprises a low-density polyethylene, a high-density polyethylene, an ultra high-density polyethylene, or a mixture thereof.

19. A method of making a feedstock, the method comprising:
feeding a film comprising a recyclable polymer material and multilayer film comprising a non-recyclable polymer material into a twin screw extruder;
extruding the feedstock, wherein the feedstock comprises:
a recyclable polymer material in a range of about 2 wt % to about 35 wt % of the feedstock; and
a non-recyclable polymer,
wherein the recyclable polymer material and portions of the non-recyclable polymer are immiscible.

20. The method of claim 19, wherein the non-recyclable polymer material comprises polyethylene terephthalate, a polyamide, a polyurethane, ethylene vinyl alcohol, or a mixture thereof combined with polyethylene or polypropylene.
